(19) United States
(12) Patent Application Publication
(10) Pub. No.: US 2023/0310127 A1
(43) Pub. Date: Oct. 5, 2023

(54) MANUFACTURING MACHINE FOR THE PRODUCTION OF A DENTAL OBJECT

(71) Applicant: Ivoclar Vivadent AG, Schaan (LI)

(72) Inventors: Sebastian GASSNER, Triesenberg (LI); Arnd PESCHKE, Planken (LI)

(21) Appl. No.: 18/192,736

(22) Filed: Mar. 30, 2023

(30) Foreign Application Priority Data
Mar. 31, 2022 (EP) 22165866.9

(51) Int. Cl. A61C 13/00; B33Y 40/00

(52) U.S. Cl. CPC A61C 13/0004; B33Y 40/00

(57) ABSTRACT

A manufacturing machine (100) for manufacturing a dental object (101), having a suspension damper (103) for slowing down the falling dental object (101).

### CROSS REFERENCE TO RELATED APPLICATIONS

This application claims priority to European Patent Application No. 22165866.9 filed on Mar. 31, 2022, the disclosure of which is incorporated herein by reference in its entirety.

### TECHNICAL FIELD

The present invention relates to a manufacturing machine for manufacturing a dental object and method for manufacturing a dental object.

### BACKGROUND

When milling a dental object, it remains connected to the blank with a holding bar and is subsequently separated manually. Depending on the diameter of the holding bar and its position, the anatomical structures designed in CAD may be severely affected.

Placement of the holding bar on proximal or occlusal surfaces or on the cavity side leads to major impairments and inaccuracies of the final restoration. Currently, the holding bars are dimensioned during fabrication so that the restoration remains attached to the blank. This requires subsequent manual separation of the holding bar. If the holding bar is separated fully automatically or reduced in diameter, the restoration will fall off and impact the bottom of the milling chamber. This impact can damage the restoration. In the machines, the impact height is therefore kept low so that there is no excessive probability of damage in the event of a fracture of the holding bar.

This may impair the clinical function of the restoration or render the restoration unusable. Particularly in the case of brittle or delicate restorations, a residual risk of damage can hardly be excluded. Even if another restoration is fabricated directly afterwards, there is a risk that the two restorations will collide and damage each other.

US 20210213580, 20210170503 and 47664704 are directed to milling methods and/or machines and are hereby incorporated by reference in their entirety.

### SUMMARY

It is the technical object of the present invention to prevent damage to a dental object after it has been manufactured in a manufacturing machine.

This technical object is solved by subject-matter according to the independent claims. Technically advantageous embodiments are the subject of the dependent claims, the description and the drawings.

According to a first aspect, the technical object is solved by a manufacturing machine for manufacturing a dental object, with a suspension damper for braking the falling dental object. The suspension damper achieves the technical advantage that kinetic energy of the falling dental object can be effectively absorbed and damage to the manufactured dental object is prevented.

In a technically advantageous embodiment of the manufacturing machine, the suspension damper comprises an elastic plastic, a sponge, a cushion, a net, a sand, a granulate, a screen, a conveyor belt, an inclined or uneven surface, a membrane or a medium. The screen may be movable or tiltable. The conveyor belt can serve to transport the dental object. This provides the technical advantage, for example, of using suspension dampers that can effectively absorb the kinetic energy.

In a further technically advantageous embodiment of the manufacturing machine, the suspension damper is formed by a container. The container can be designed as a liquid container for holding a liquid. This provides the technical advantage, for example, that even fragile or delicate dental objects can be effectively caught.

In a further technically advantageous embodiment of the manufacturing machine, the bottom of the container comprises an inclined surface. The inclined surface can be used as a suspension damper. This provides, for example, the technical advantage of allowing the dental object to slide down the surface to a designated location.

In a further technically advantageous embodiment of the manufacturing machine, the container comprises a screen for catching the dental object. This provides the technical advantage, for example, of preventing the dental object from sinking to the bottom of the container.

In a further technically advantageous embodiment of the manufacturing machine, the screen can be moved out of the container. This provides, for example, the technical advantage that the dental object can be easily removed from the container and allowed to drip on the screen.

In a further technically advantageous embodiment of the manufacturing machine, the container or screen can be tilted. This provides, for example, the technical advantage that the dental object can be removed laterally.

In a further technically advantageous embodiment of the manufacturing machine, the container comprises a conveyor belt for transporting the dental object out. This provides, for example, the technical advantage that the dental object can be automatically transported out of the container.

In a further technically advantageous embodiment of the manufacturing machine, the manufacturing machine is a milling machine or a 3D printer. This provides, for example, the technical advantage that the dental object can be manufactured in an efficient manner.

According to a second aspect, the technical problem is solved by a method for manufacturing a dental object, comprising the steps of manufacturing a dental object; and catching the falling dental object by a suspension damper. Thereby, the same technical advantages are provided as by the manufacturing machine according to the first aspect.

In a technically advantageous embodiment of the method, the dental object is slowed down by a liquid within the suspension damper. This provides the technical advantage, for example, that one or more dental objects can be cushioned without damaging each other.

In a further technically advantageous embodiment of the method, the dental object is moved out of the liquid by a movable screen or conveyor belt. This provides, for example, the technical advantage that the dental object can be easily removed from the container and can drip on the screen.

In a further technically advantageous embodiment of the method, the screen is tilted to eject the dental object. This provides, for example, the technical advantage that the dental object can be removed laterally to a predetermined position.

In a further technically advantageous embodiment of the method, the screen is rotated to eject the dental object. This provides, for example, the technical advantage that the dental object is moved outward.

In a further technically advantageous embodiment of the method, the method is a milling method or a three-dimensional printing method. This provides, for example, the technical advantage that the dental object can be produced in a simple manner.

### BRIEF DESCRIPTION OF THE DRAWINGS

Examples of embodiments of the invention are shown in the drawings and are described in more detail below.

The figures show:

FIG. 1 a schematic representation of a manufacturing machine;

FIG. 2A a further embodiment of the manufacturing machine with a conveyor belt;

FIG. 2B a further embodiment of the production machine with a movable screen in a container;

FIG. 3A a further embodiment of the production machine with a screen;

FIG. 3B further embodiments of the manufacturing machine with a cushion;

FIG. 3C further embodiments of the manufacturing machine with a granule;

FIG. 4 another embodiment of the manufacturing machine having a coating nozzle; and

FIG. 5 a block diagram of a method for manufacturing a dental object.

### DETAILED DESCRIPTION

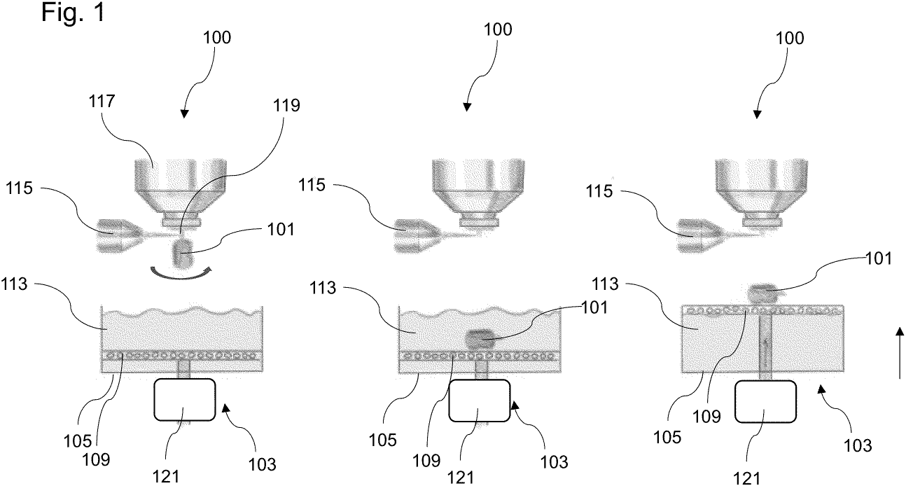

FIG. 1 shows a schematic representation of a manufacturing machine 100. The manufacturing machine 100 is used to manufacture a dental object 101. A dental object 101 is, for example, a crown, a bridge, a veneer, an abutment, an inlay, an onlay, a splint or a partial or full denture. In general, the dental object 101 can be any object in the dental field that is to be fabricated as part of a dental treatment.

For example, the manufacturing machine 100 may be a milling machine with a milling head 115. The dental object 101 is attached to the rotary spindle 117, which rotates the dental object 101 relative to the milling head 115. Through the milling machine, the rotating dental object 101 is produced by means of a machining process. At the end of the machining process, the dental object 101 still remains connected to the rotary spindle 117 via a thin holding bar 119. If the holding bar 119 is also subsequently separated, the dental object 101 falls down a distance in free fall under the influence of gravity.

To prevent damage to the dental object 101 upon impact, the milling chamber of the manufacturing machine 100 includes an open-topped container 105 as a suspension damper 103. The container 105 is disposed below the rotary spindle 117 on which the dental object 101 is milled.

The container 105 includes a liquid 113, such as water, or other medium to reduce the rate of fall of the dental object 101 without damaging it. The liquid may be a cooling or grinding liquid used to cool the dental object 101 during the manufacturing method and thereby collected by the container 105, or may be formed by a granular material or sand. However, in general, another suspension damper may be used to slow down the dental object 101.

Instead of liquid, the medium can be a bed of sand such as ball bed sand or granules in a tub. Other suspension dampers 103 can be other materials that achieve a springing and damping effect, such as a soft plastic, a sponge, a cushion, a net, a damping mat or a membrane. These suspension dampers 103 can also prevent damage to the dental object.

When immersed in the liquid, the falling speed of the dental object 101 is reduced such that it falls or slides at a slow speed to the bottom of the container 105. Also, when a second dental object 101 is produced and caught, it is also slowed by the decelerating effect of the liquid. Therefore, the other dental object 101 also has a reduced impact velocity when it collides with one of the other dental objects 101 at the bottom of the liquid. As a result, numerous dental objects 101 can be made one after another without damaging each other.

The milled dental object(s) 101 can be caught by the free fall without being damaged. The user then receives dental objects 101 with a more accurate shape. In addition, the holding bar 119 that attaches the dental object 101 to the rotary spindle 117 does not need to be manually separated, but can be separated as part of the milling method. The holding bar 119 can be reduced to a minimum diameter or completely separated at the end of the manufacturing method. This results in a reduced need for manual finishing.

A height-adjustable screen 109 is in the liquid. The screen 109 can be moved in height by a lifting unit 121. During the production and separation process of the dental object, the screen 109 is in such a low position that the dental object 101 falls into the rinsing liquid during separation and is thus braked. After being slowed down by the liquid, the dental object 101 hits the screen 109, which is in the liquid.

After the manufacturing method is finished, the screen 109 moves upwards until it is above the surface of the liquid. For this purpose, the lifting unit 121 moves the screen 109 in a vertical direction. Thus, the dental object 101 is conveyed to a position where the dental object 101 can drip off and the user can easily remove it.

The anatomical structures of the dental object 101 can be precisely worked out according to a CAD template. The manufacturing machine 100 prevents even extremely brittle materials of the dental object 101 from being damaged after cutting. This reduces the need for manual reworking, anatomical structures of the dental object 101 can be manufactured more accurately, and additional options for the position of the holding bar can be realized. Damage when the dental object 101 falls down is excluded.

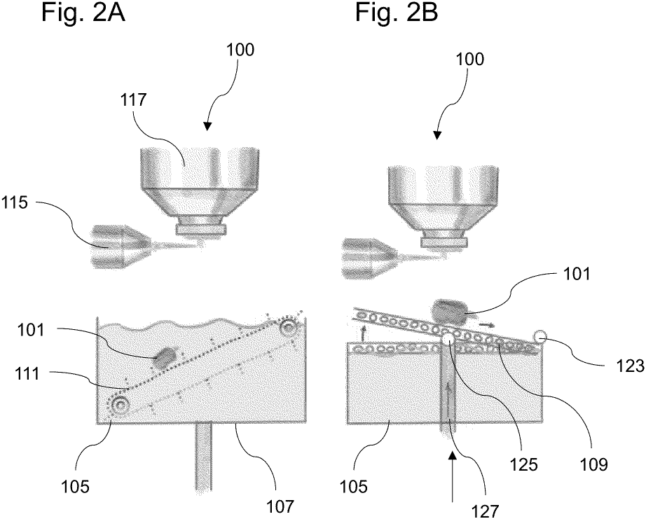

FIG. 2A shows another embodiment of the manufacturing machine 100. The container 105 includes a conveyor belt 111 disposed in the liquid and falling onto the dental object 101. The container 105 may be in the form of a liquid container. The liquid container may receive a liquid that is used to decelerate the falling dental object. However, in general, a container 105 in which a suspension damper 103 other than a liquid is disposed may also be used.

The conveyor belt 111 is arranged at an angle in the container 105 and can convey the dental object 101 out of the liquid. This allows the dental object 101 to be transferred to the user at a specific position.

The surface 107 at the bottom of the container 105 may also be sloped, trough-shaped, or funnel-shaped, so that the dental object 101 is moved in a particular direction via gravity. The dental object 101 then sinks to the lowest point in the container 105. However, the dental object 101 can also be moved out of the falling area of the liquid via another conveying mechanism, such as a rotary plate or a screen insert.

FIG. 2B shows another embodiment of the manufacturing machine 100, but the manufacturing machine 100 may also comprise a screen 109 that is rotatably supported at the end of the lifting rod 127 at a pivot point 125. When the screen 109 is moved upward, the screen 109 abuts the lateral stop point 123 and thereby tilts to the side. In this way, the dental object 101 can be easily removed from the liquid and then discharged laterally. Alternatively, the dental object 101 can also be conveyed out of the drop zone via a chute and discharged laterally.

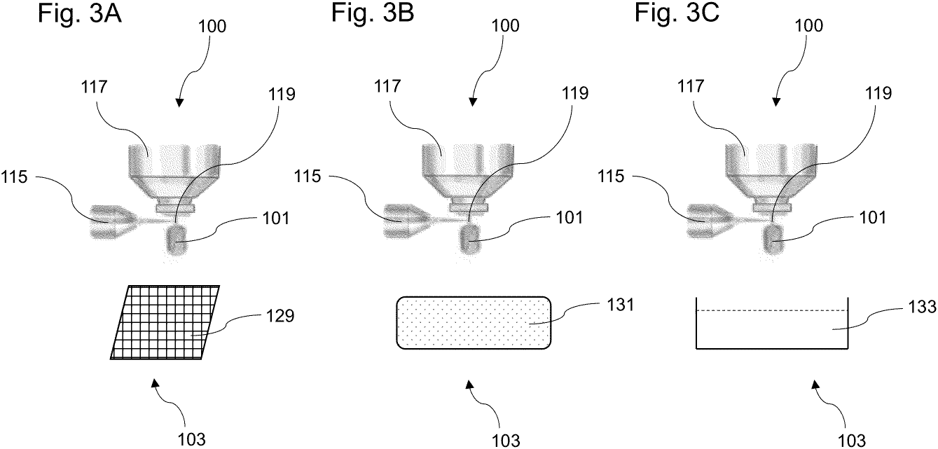

FIG. 3A shows another embodiment of the manufacturing machine with an elastic screen or mesh 129 as a suspension damper 103. FIG. 3B shows another embodiment of the manufacturing machine with an elastic cushion or sponge 131 as a suspension damper 103. FIG. 3C shows another embodiment of the manufacturing machine with a granule or sand 133 as a suspension damper 103. In general, the suspension damper 103 may also be formed by a conveyor belt, an inclined surface, or a membrane. For example, the suspension damper 103 may be formed by an elastic material that is placed around the dental object 101 and then removed, such as a foam, a wax, or a light-curable monomer. The elastic material may surround all or part of the dental object 101.

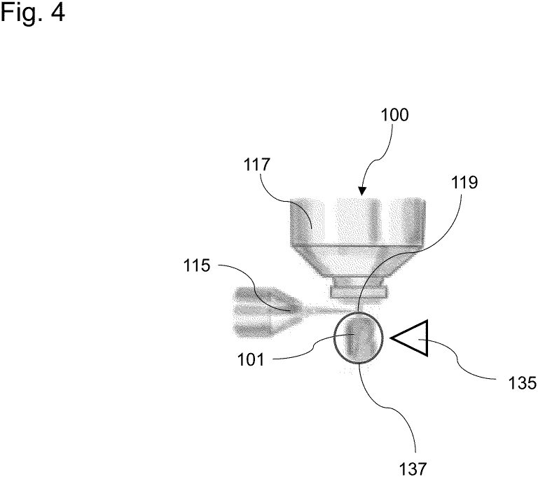

FIG. 4 shows another embodiment of the manufacturing machine with a coating nozzle 135. The dental object 101 is coated with a medium 137 as a suspension damper for protection prior to free fall through the coating nozzle 135. This medium 137 as a suspension damper may be, for example, a foam, a wax, or a light-curing monomer that is placed around the dental object 101 and then removed. The medium cushions the impact of the falling dental object 101 and prevents damage. In general, the medium 137 can be any medium suitable for dampening the impact of the falling dental object 101.

The application of the medium 137 is achieved, for example, through the coating nozzle 135 on the rotating spindle 117. This allows the rotating dental object 101 to be completely enclosed by the medium 137.

The medium 137 may exit from an object holder or the medium 137 may flow down the dental object 101 from top to bottom. The medium 137 can also be applied to the dental object 101 only selectively or in partial areas in order to protect only certain surfaces upon impact.

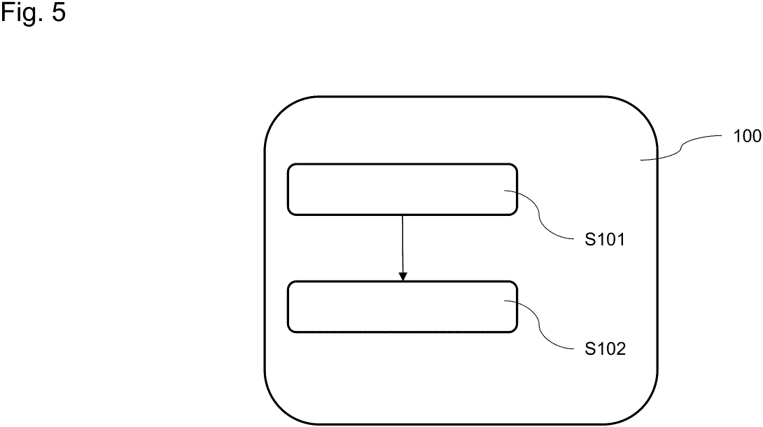

FIG. 5 shows a block diagram of a method for manufacturing the dental object 101. The method is performed within a manufacturing machine 200 for the manufacturing method. First, the dental object 101 is manufactured in step S101. In this step, the dental object 101 is released from a manufacturing platform or rotating spindle. Then, the falling dental object 101 is caught by the suspension damper 103 in step S102. The manufacturing method can be an additive manufacturing method, such as a 3D printing method, or a subtractive manufacturing method, such as a milling method.

All features explained and shown in connection with individual embodiments of the invention may be provided in different combinations in the subject-matter of the invention to simultaneously realize their beneficial effects.

All method steps can be implemented by means which are suitable for executing the respective method step. All functions that are executed by the objective features can be a method step of a method.

The scope of protection of the present invention is given by the claims and is not limited by the features explained in the description or shown in the figures.

REFERENCE LIST

| | |
|---|---|
| 100 | Manufacturing machine |
| 101 | Dental object |
| 103 | Suspension damper |
| 105 | Container |
| 107 | Inclined surface |
| 109 | Screen |
| 111 | Conveyor belt |
| 113 | Liquid |
| 115 | Milling head |
| 117 | Turning spindle |
| 119 | Holding bar |
| 121 | Lifting unit |
| 123 | Stop point |
| 125 | Pivot point |
| 127 | Lifting rod |
| 129 | Screen |
| 131 | Cushion |
| 133 | Granules |
| 135 | Coating nozzle |
| 137 | Medium |

1. A manufacturing machine (100) for manufacturing a dental object (101), comprising:
a suspension damper (103) for slowing down the falling dental object (101).

2. The manufacturing machine (100) according to claim 1,
wherein the suspension damper (103) comprises an elastic plastic, a sponge, a cushion, a net, a sand, a granule, a screen, a conveyor belt, an inclined or uneven surface, a membrane, or a medium.

3. The manufacturing machine (100) according to claim 1,
wherein the suspension damper (103) comprises a container (105).

4. The manufacturing machine (100) according to claim 3,
wherein a bottom of the container (105) comprises an inclined surface (107).

5. The manufacturing machine (100) according to claim 3,
wherein the container (105) comprises a screen (109) for catching the dental object (101).

6. The manufacturing machine (100) according to claim 5,
wherein the screen (109) is movable out of the container (105).

7. The manufacturing machine (100) according to claim 5,
wherein the container or screen (109) is tiltable.

8. The manufacturing machine (100) according to claim 3,
wherein the container (105) comprises a conveyor belt (111) for transporting out the dental object (101).

9. The manufacturing machine (100) according to claim 1,
wherein the manufacturing machine (100) is a milling machine or a 3D printer.

10. A method of manufacturing a dental object (101), comprising the steps of:
manufacturing (S101) a dental object (101); and
catching (S102) the falling dental object (101) by a suspension damper (103).

11. The method according to claim 10,
wherein the dental object (101) is slowed down by a liquid (113) within the suspension damper (103).

12. The method according to claim 11,
wherein the dental object (101) is moved out of the liquid (113) by a movable screen (105) or conveyor belt (111).

13. The method according to claim 12,
wherein the screen (109) is tilted to eject the dental object (101).

14. The method according to claim 12,
wherein the screen (109) is rotated to eject the dental object (101).

15. The method according to claim 10,
wherein the method is a milling method or a three-dimensional printing method.
